(19) United States
(12) Patent Application Publication
(10) Pub. No.: US 2024/0257305 A1
(43) Pub. Date: Aug. 1, 2024

(54) METHOD AND APPARATUS FOR RECONSTRUCTING OBJECT FROM DISTORTED IMAGE

(71) Applicant: UNIST (ULSAN NATIONAL INSTITUTE OF SCIENCE AND TECHNOLOGY), Ulsan (KR)

(72) Inventors: Chung Hun Park, Ulsan (KR); Byung Jae Hwang, Ulsan (KR)

(73) Assignee: UNIST (ULSAN NATIONAL INSTITUTE OF SCIENCE AND TECHNOLOGY), Ulsan (KR)

(21) Appl. No.: 18/564,423

(22) PCT Filed: Mar. 28, 2022
(86) PCT No.: PCT/KR2022/004309

§ 371 Date: Nov. 27, 2023

(30) Foreign Application Priority Data
May 27, 2021 (KR) 10-2021-0068612

(51) Int. Cl. G06T 5/10; G06T 7/32; G06T 7/33; G06T 11/00

(52) U.S. Cl. CPC G06T 5/10; G06T 7/32; G06T 7/33; G06T 11/00; G06T 2207/10028; G06T 2207/10116; G06T 2207/10132; G06T 2207/20021; G06T 2207/20048

(57) ABSTRACT

A method for reconstructing an object from distorted images, according to an embodiment of the present invention, comprises the steps of: acquiring a plurality of original images including a distorted region; extracting a Fourier phase with respect to the original images; extracting a Fourier amplitude with respect to the original images; and acquiring a reconstructed image in which the distorted region has been reconstructed by performing inverse Fourier transform on a value obtained by multiplying the Fourier phase and the Fourier amplitude, wherein the step of extracting the Fourier phase and the step of extracting the Fourier amplitude are performed independently of each other.

### DESCRIPTION

### Technical Field

The present disclosure relates to a method and apparatus for reconstructing an object from distorted images, and more particularly, to a method and apparatus for reconstructing a distorted image by accurately extracting a Fourier phase and a Fourier amplitude of an object to be reconstructed using the distorted images only.

### Background Art

One of the reasons why long-distance imaging is difficult is due to surrounding medium, such as the atmosphere, that changes irregularly between an object and a camera. The atmosphere moves in real time due to changes in temperature or composition, which causes a distortion in an acquired image in different ways each time a measurement is made. To solve the issue of image distortion caused by such an irregular medium, a wavefront correction device has been used. This device can correct distortions caused by the atmosphere by measuring the distribution of the atmosphere existing between the object and the camera and using a device capable of correcting a distortion caused thereby. As such, hardware-based technology operates in a limited environment, is used in a limited situation due to its large size, and is difficult to use in various situations due to sensitivity to temperature or vibration. Furthermore, unless an object to be observed and supplementary equipment are firmly arranged in a rigid setup, it is difficult to expect distortion correction to be applicable. In addition, it is expensive and thus difficult to apply to various situations. Such limitations or constraints in the usage environment and high costs hinder the hardware-based technology from being widely used.

Meanwhile, image reconstruction methods using computation algorithms to overcome the shortcomings of hardware-based image correction have been developed. One classic method is Labeyrie's approach, which is a method of reconstructing an image using only distorted images without using the devices mentioned above. This method uses the power spectrums of acquired images. The average power spectrum of the acquired images may be used as a value to estimate the Fourier amplitude of an object to be reconstructed. When the Fourier amplitude is known, the Fourier phase may be reconstructed using a phase reconstruction algorithm, which estimates the Fourier amplitude of the object from the average power spectrum and calculates the Fourier phase through an iterative phase reconstruction algorithm. By combining the Fourier phase and amplitude reconstructed as described above, a distortion-free object is reconstructed. However, such phase reconstruction algorithm-based methods have significant limitations in that the size of an object to be reconstructed is limited compared to the size of an acquirable image. There is a prerequisite that an object to be reconstructed in an acquired image is limited to a small region, and otherwise, it is impossible to reconstruct the object using conventional iterative phase retrieval algorithms. Furthermore, an image computed as a result of the algorithm may change according to various parameters used in the algorithm. Since a unique solution is not guaranteed, it is impossible to determine what an actual object is only with the results computed by the algorithm. To overcome such limitations, methods of reconstructing a Fourier phase of an object to be reconstructed in an acquired image have been studied. Although various image reconstruction algorithms use distorted images, those algorithms have an issue of a slow reconstruction speed or a low quality of restored images.

### DISCLOSURE OF THE INVENTION

### Technical Goals

To solve the issues described above, the present disclosure provides a method and apparatus for reconstructing an image using a quick and simple algorithm. The diffraction limited resolution of the imaging system can be recovered in a reporducible manner using a simple operation to extract the Fourier phase and Fourier amplitude of the object.

### Technical Solutions

According to an embodiment of the present disclosure, a method of reconstructing an object from a distorted image includes acquiring a plurality of original images including a distorted region; extracting the Fourier phase with respect to the original images; extracting the Fourier amplitude with respect to the original images; and acquiring a reconstructed image in which the distorted region has been reconstructed by performing an inverse Fourier transform on a value obtained by multiplying the Fourier phase and the Fourier amplitude, wherein the extracting of the Fourier phase and the extracting of the Fourier amplitude are performed independently of each other.

The extracting of the Fourier phase may include acquiring an aligned image set by aligning the plurality of original images using shift correction; acquiring an average image of the aligned image set; and extracting the Fourier phase from the average image.

The extracting of the Fourier phase may include selecting a reference image that is a reference for shift correction from among the plurality of original images; performing shift correction with respect to the plurality of original images including the reference image based on the reference image using a cross-correlation operation that calculates a correlation with the reference image; acquiring a summed image by summing the shift-corrected images; and calculating a Fourier phase of the summed image.

The plurality of original images may be acquired as a plurality of images from different timepoints.

The plurality of original images may be acquired by dividing a single original image acquired as a single image from one timepoint into a plurality of sub-images satisfying an isoplanatic condition.

The method may further include, after the acquiring of the reconstructed image, determining whether an iteration count reaches a preset maximum iteration count, wherein when the iteration count does not reach the preset maximum iteration count yet in the determining, the method may determine a reconstructed image acquired most recently to be a reference image for a next cycle, and acquire a subsequent reconstructed image by extracting the Fourier phase and the Fourier amplitude with respect to the same plurality of original images.

In the acquiring of the original images, the original images may be acquired by being captured by a spatial sensor device including at least one of a camera, an ultrasonic sensor, a radio antenna, or an X-ray detector.

According to an embodiment of the present disclosure, an apparatus for reconstructing an object from a distorted image includes a processor, wherein the processor is configured to acquire a plurality of original images including a distorted region, extract a Fourier phase with respect to the original images, extract a Fourier amplitude with respect to the original images, and acquire a reconstructed image in which the distorted region has been reconstructed by performing an inverse Fourier transform on a value obtained by multiplying the Fourier phase and the Fourier amplitude, wherein the extracting of the Fourier phase and the extracting of the Fourier amplitude are performed independently of each other.

### Effects

According to embodiments of the present disclosure, it is possible to reconstruct an object from a distorted image quickly, simply, accurately up to the diffraction limit, and stably with a simple operation using extraction of a Fourier phase and a Fourier amplitude.

### BRIEF DESCRIPTION OF DRAWINGS

FIG. 1 is a block diagram schematically illustrating the configuration of an image reconstruction apparatus according to an embodiment of the present disclosure.

FIG. 2 is a flowchart for describing an image reconstruction method according to an embodiment of the present disclosure.

FIG. 3 is a flowchart for describing an operation of extracting a Fourier phase according to an embodiment of the present disclosure.

FIG. 4 is a flowchart for describing an image reconstruction method from a mathematical perspective according to an embodiment of the present disclosure.

FIG. 5 is a mimetic diagram for describing an image reconstruction method using example images according to an embodiment of the present disclosure.

FIG. 6 is a mimetic diagram for describing an image reconstruction method using example images according to another embodiment of the present disclosure.

### BEST MODE FOR CARRYING OUT THE INVENTION

As one or more embodiments of the present disclosure allow for various changes and numerous embodiments, particular embodiments will be illustrated in the drawings and described in detail in the written description. The effects and features of the present disclosure, and the methods for achieving the same will be apparent when reference is made in more detail to embodiments, examples of which are illustrated in the accompanying drawings. However, the present disclosure is not limited to the embodiments set forth hereinafter but may be implemented in various forms.

Hereinafter, embodiments of the present disclosure will be described in detail with reference to the accompanying drawings. In describing with reference to the drawings, those components that are the same or are in correspondence are rendered the same reference numeral, and a duplicate description thereof is omitted.

In the following embodiments, the terms “first”, “second”, and the like do not have limited meaning but are used for the purpose of distinguishing one element from another clement. In the following examples, the singular forms “a”, “an” and “the” include plural referents unless the context clearly dictates otherwise. In the following examples, the term “comprising” or “having” is meant to imply the presence of a feature or element described in the specification and does not preclude the possibility that one or more other features or elements may be added. In the drawings, elements may be exaggerated or reduced in size for convenience of description. For example, the sizes and shapes of the respective elements shown in the drawings are arbitrarily shown for convenience of description, and thus, the present disclosure is not necessarily limited thereto.

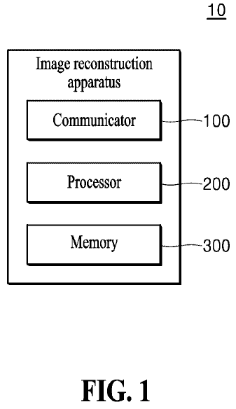

FIG. 1 is a block diagram schematically illustrating the configuration of an image reconstruction apparatus 10 according to an embodiment of the present disclosure.

The image reconstruction apparatus 10 includes a communicator 100, a processor 200, a memory 300.

The communicator 100 may communicate with various types of external devices and/or external servers (not shown) according to various types of communication methods.

The processor 200 may perform an operation of generally controlling the image reconstruction apparatus 10 using various types of programs stored in the memory 300. The processor 200 may be configured to process instructions of a computer program by 20 performing fundamental arithmetic, logic, and input/output operations. The instructions may be provided to the processor 200 by the communicator 100 or the memory 300. For example, the processor 200 may be configured to execute instructions received according to program code stored in a recording device such as the memory 300. The processor 200 may include processing devices such as a microprocessor, a central processing unit (CPU), a processor core, a multiprocessor, an application-specific integrated circuit (ASIC), a field programmable gate array (FPGA), and the like, but is not limited thereto.

The memory 300 may function to temporarily or permanently store data processed by the image reconstruction apparatus 10. The memory 300 may include permanent mass storage devices such as random-access memory (RAM), read-only memory (ROM), and a disk drive, but the scope of the present disclosure is not limited thereto. 30

Although not shown in the drawings, the image reconstruction apparatus 10 may further include an input/output interface. The input/output interface (not shown) may be a means for interface with an input/output device (not shown). For example, the input device may include a device such as a keyboard or a mouse, and the output device may include a device for displaying an image, such as a display. As another example, the input/output interface (not shown) may be a means for interface with a device in which the functions for input and output are integrated, such as a touch screen.

According to an embodiment of the present disclosure, the processor 200 may easily and quickly reconstruct an image using a simple algorithm that extracts the Fourier phase and Fourier amplitude from an original image (hereinafter, simply referred to as the “original image” or “distorted image”) including a distorted region and performs an inverse transform on the same. The detailed operation of the processor 200 will be described further in detail using the following drawings.

The image reconstruction apparatus 10 of the present disclosure may further include elements other than the elements shown in FIG. 1, and the communicator 100 may be omitted, as necessary.

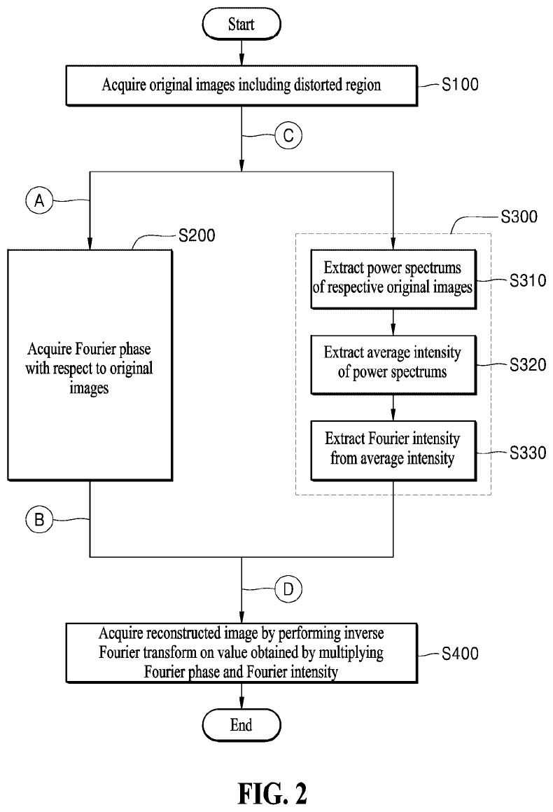

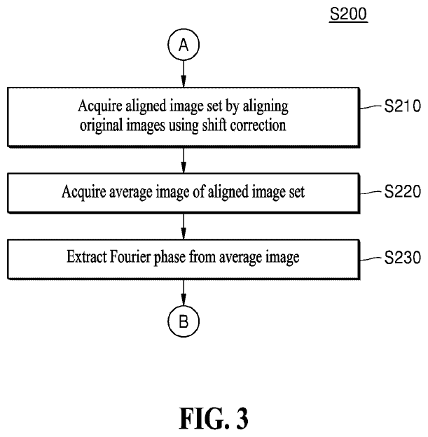

Hereinafter, an image reconstruction method according to an embodiment of the present disclosure will be described with reference to FIGS. 2 and 3 together. FIG. 2 is a flowchart for describing the image reconstruction method according to an embodiment of the present disclosure, and FIG. 3 is a flowchart for describing operation S200 of extracting a Fourier phase according to an embodiment of the present disclosure. The image reconstruction method described below may be performed by the processor 200 described above.

First, a plurality of original images including a distorted region are acquired (S100). At this time, the original images may be acquired as a plurality of images from different timepoints. Alternatively, the original images may be acquired as a plurality of images at different positions.

The original images of the present disclosure do not depend on the wavelength and may be applied not only to images in the visible wavelengths but also to images/signals of all electromagnetic wave bands such as ultraviolet rays, infrared rays, X-rays, radio, and the like and of all waves such as ultrasounds. The original images of the present disclosure are not limited to the wavelength over which the original images are acquired.

At this time, the original images of the present disclosure may be acquired as being captured by a spatial sensor device including a camera, an ultrasonic sensor, a radio antenna, an X-ray detector, and the like.

According to an embodiment, the original images may be acquired as a single image from one timepoint. At this time, the single original image may be divided into a plurality of sub-images satisfying an isoplanatic condition. The “isoplanatic condition” may be the range for evaluating a distortion in the original image as a distortion caused by a single point spread function. This may be expressed mathematically, as in [Equation 1] below.

$${I}_{sub} ( x ) = {O}_{sub} ( x ) * {PSF}_{sub} ( x ) \qquad [ Equation 1 ]$$

At this time, Isub(x) denotes one divided sub-image, Osub(x) denotes a plurality of sub-images when each sub-image has no distortion, and PSFsub(x) denotes a distortion caused by a medium. The medium changes according to the time of acquisition or position of acquisition each time the original images are acquired, and the manner and degree of the distortion in each original image varies. Thus, PSFsub(x) may also vary for each original image or each sub-regions of the original image.

That is, the plurality of original images described above may be a plurality of original images including the same region or a plurality of sub-images acquired by dividing the original image into sub-regions where PSFsub(x) is invariant.

Thereafter, a Fourier phase with respect to the original images is acquired (S200). Here, operation S200 will be described with reference to FIG. 3 together. Operation S200 may include operations described below.

First, an aligned image set is acquired by aligning the plurality of original images using shift correction (S210). At this time, in the case of a plurality of original images, it may be interpreted as aligning the plurality of original images, and in the case of a single original image, it may be interpreted as aligning a plurality of sub-images acquired by dividing the single original image. More specifically, a plurality of original images distorted differently may be aligned by performing shift correction thereon based on one arbitrarily selected original image. Hereinafter, the one original image being the reference may be referred to as the reference image. The aligned plurality of original images acquired by shift correction as described above is referred to as the aligned image set.

Thereafter, an average image is acquired by summing the respective images in the aligned image set and calculating an average thereof (S220). Specifically, the plurality of original images shift-corrected and aligned based on the reference image may be summed after matching their positions. Thereafter, the average image may be acquired by calculating the average according to the number of original images summed.

Thereafter, a Fourier phase is extracted from the average image and determined to be a Fourier phase of the original images (S230). This may be expressed mathematically, as in [Equation 2].

$$∠ℱ \{ {O}_{sub} ( x ) \} = ∠ℱ \{ {\sum }_{k} {I}_{sub , {t}_{k}}^{′} ( x ) \} \qquad [ Equation 2 ]$$

At this time, ∠ [symbol] {O_{sub}(x)} denotes a Fourier phase of an original image (target image) to be reconstructed,

$${\sum }_{k} {I}_{sub , {t}_{k}}^{′} ( x )$$

denotes a summed image of images shift-corrected based on cross-correlations of the respective plurality of original, and

$$∠ F \{ {\sum }_{k} {I}_{sub , {t}_{k}}^{′} ( x ) \} ,$$

a Fourier phase thereof, is used as the Fourier phase of the target image.

Meanwhile, independently of operation S200 described above, a Fourier amplitude with respect to the original images is acquired (S300). In this case, operation S300 of acquiring the Fourier amplitude is performed independently of operation S200 of acquiring the Fourier phase described above. That is, in the method of reconstructing an image from a distorted image of the present disclosure, the Fourier phase and the Fourier amplitude are extracted not sequentially, but independently and in parallel. Here, referring back to FIG. 2, operation S300 may include operations described below.

First, power spectrums of the respective plurality of original images I_{sub,t}_{₁}(x), I_{sub,t}_{₂}(x), . . . , I_{sub,t}_{ₖ}(x) are extracted (S310), and an average intensity of the plurality of power spectrums is extracted (S320).

Thereafter, the square root of the average intensity is extracted as a Fourier amplitude of a target image in which an object is to be reconstructed (S330).

Thereafter, a reconstructed image is acquired by performing an inverse Fourier transform on the value obtained by multiplying the Fourier phase acquired in operation S200 and the Fourier amplitude acquired in operation S300. The reconstructed image acquired by the inverse Fourier transform is O_{sub}(x) in [Equation 1].

Much research has been conducted on methods of recovering a Fourier amplitude for image reconstruction, but it is difficult to retrieve a Fourier phase of an object to be reconstructed and various methods therefor have been recently studied. A representative method is an image reconstruction method using a dual spectrum, and this method has a considerable amount of computation and requires a long reconstruction time since the size of a dual spectrum is determined to be a size corresponding to the square of an acquired image. To solve this issue, hardware capable of processing parallel computation is used, but the computation process of calculating a dual spectrum of the acquired images and reconstructing an image is still too complex and difficult to use widely. In addition, although various other image reconstruction algorithms use distorted images, those algorithms have an issue of a low image reconstruction speed or a low quality of reconstructed images.

An image reconstruction method and computer program according to an embodiment of the present disclosure may reconstruct a Fourier phase of an object, randomly distorted due to a random change in a medium, accurately and stably up to the diffraction limit through a simple operation of summing and averaging shift-corrected images with respect to a plurality of original images. Since an average operation of the acquired original images is used, the computation result tends to converge to the object to be reconstructed, and thus, it is stable compared to existing algorithms.

Furthermore, it is possible to not only reconstruct a distorted image simply and quickly, but also simplify image reconstruction by computing the same result all the time without information being a reference for the object to be reconstructed or information about parameters used differently for each reconstruction apparatus. Further, since an additional process is unnecessary compared to the existing algorithms solving an optimization problem, it may be used in various image reconstruction systems, such as, to implement real-time image reconstruction with a small-sized computation device such as a smartphone.

According to embodiments of the present disclosure, it may be immediately applicable to environments where it is generally difficult to acquire a high-quality image, such as imaging through vibrations, nonuniform air density distributions, and opaque media, thereby reconstructing the best image quality corresponding to a diffraction limit. Accordingly, the embodiments of the present disclosure may be used in various fields such as long-distance imaging through atmospheric disturbance, unmanned surveillance using closed-circuit television (CCTV), and the like, and industrial machine vision for precise quality measurement.

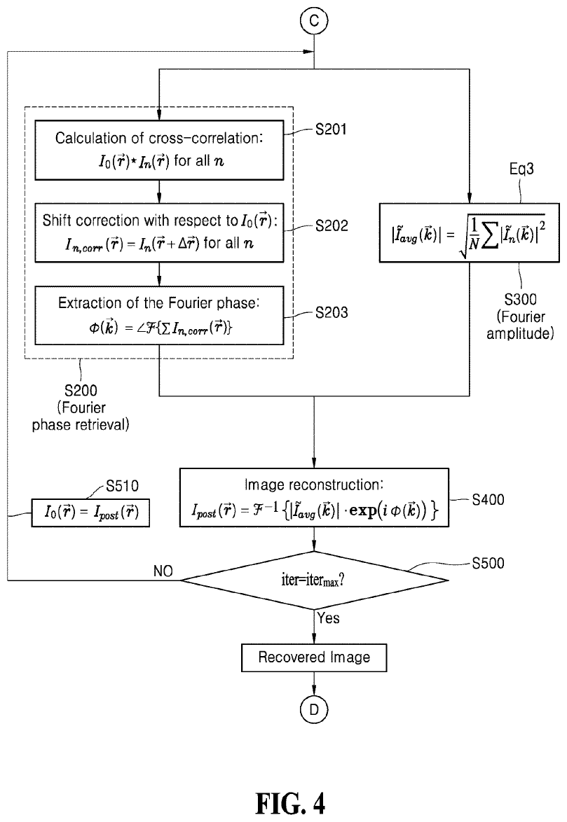

FIG. 4 is a flowchart for describing an image reconstruction method from a mathematical perspective according to an embodiment of the present disclosure. Hereinafter, for convenience of description, operation S300 will be described first.

Hereinafter, Iₙ(\vec{r}) denotes an n-th original image among a plurality of original images, Ĩₙ(\vec{k}) denotes a Fourier-transformed image of Iₙ(\vec{r}), Iₒ(\vec{r}) denotes a reference image being the reference of shift correction based on cross-correlation, and I_{n,corr}(\vec{r}) denotes a shift-corrected n-th image.

Referring to the following Equation 3 in operation S300, the root mean square (rms) of Fourier intensities |Iₙ(\vec{r})| of the respective plurality of original images is extracted as the Fourier amplitude (S300).

$$\vert {\tilde{I}}_{avg} ( \vec{k} ) \vert = \sqrt{\frac{1}{N} \sum {\vert {\tilde{I}}_{n} ( \vec{k} ) \vert}^{2}} \qquad [ Equation 3 ]$$

Meanwhile, operation S200 of extracting the Fourier phase may be performed by operations expressed by the following equations.

First, a reference image Iₒ(\vec{r}) to be used as a reference for shift correction is arbitrarily selected from among n original images. Thereafter, a cross-correlation operation of calculating the correlation between itself Iₙ(\vec{r}) and the reference image Iₒ(\vec{r}) is performed for all the n original images including the reference image. This may be expressed mathematically, as in the following Equation 4. At this time, the cross-correlation operation may be a convolution operation, for example, but is not limited thereto, and may be any operation that represents a correlation between different images. For example, the cross-correlation operation may be implemented as multiplication in a Fourier domain to increase the computation speed.

$${I}_{O} ( \vec{r} ) ★ {I}_{n} ( \vec{r} ) \qquad [ Equation 4 ]$$

Thereafter, by performing shift correction on all the n original images Iₙ(\vec{r}) based on the reference image Iₒ(\vec{r}), an alignment image set including n shift-corrected images I_{n,corr}(\vec{r}) is acquired. This may be expressed by the following Equation 5.

$${I}_{n , corr} ( \vec{r} ) = {I}_{n} ( \vec{r} + Δ \vec{r} ) \qquad [ Equation 5 ]$$

Thereafter, a summed image ΣI_{n,corr}(\vec{r}) is calculated by summing all the n shift-corrected images I_{n,corr}(\vec{r}) in the aligned image set, where the summed image ΣI_{n,corr}(\vec{r}) may be the average of the summed n images. In addition, a Fourier phase ∠ [symbol] {ΣI_{n,corr}(\vec{r})} of the summed image may be calculated and determined to be a Fourier phase φ(\vec{k}) used in the image reconstruction method of the present disclosure. This may be expressed mathematically, as in Equation 6.

$$ϕ ( \vec{k} ) = ∠ℱ \{ \sum {I}_{n , corr} ( \vec{r} ) \} \qquad [ Equation 6 ]$$

When the Fourier amplitude |Ĩ_{avg}(\vec{k})| and the Fourier phase φ(\vec{k}) of the present disclosure are calculated as described above, a reconstructed image Iₚₒₛₜ(\vec{r}) is acquired by multiplying the two values and performing an inverse Fourier transform thereon (S400). This may be expressed mathematically, as in Equation 7.

$${I}_{post} ( \vec{r} ) = {{ℱ}^{- 1}}^{‐} \{ \vert {\tilde{I}}_{avg} ( \vec{k} ) \vert \cdot exp ( i ϕ ( \vec{k} ) ) \} \qquad [ Equation 7 ]$$

Thereafter, operations S201, S202, S203, and S400 may be iterated using the reconstructed image Iₚₒₛₜ(\vec{r}) finally acquired according to additional predetermined criteria as an initial reconstructed image (S500).

More specifically, when the reconstructed image is acquired in operation S400, the processor 200 may determine whether an iteration count iter reaches a maximum iteration count itermax according to the reference preset in the processor 200 and/or the memory 300 (S500).

When the iteration count has not reached the maximum iteration count itermax yet, the processor 200 may determine the reconstructed image Iₚₒₛₜ(\vec{r}) acquired most recently to be a reference image Iₒ(\vec{r}) for the next cycle (S510), and acquire a subsequent reconstructed image by sequentially performing operations S201, S202, S203, and S400. When the iteration count is equal to the preset maximum iteration count itermax, the most recently acquired reconstructed image may be determined to be the final reconstructed image, and the image reconstruction method may end.

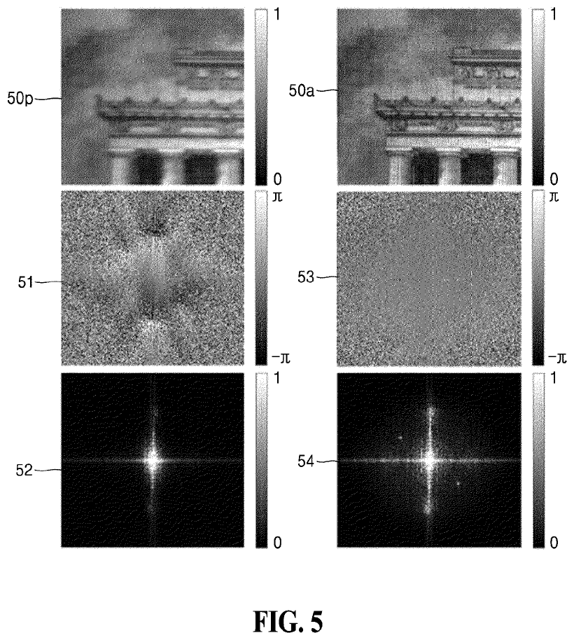

FIG. 5 is a mimetic diagram for describing an image reconstruction method using example images according to an embodiment of the present disclosure. Left images 50p, 51, and 52 of FIG. 5 are images acquired in a distorted state before reconstruction, and right images 50a, 53, and 54 are images acquired in a reconstructed state. Referring to the left side first, 50p is one of the plurality of original images including a distorted region and may correspond to Iₚₒₛₜ(\vec{r}) described above or ΣI_{n,corr}(\vec{r}) that is an image shift-corrected therefrom. 51 is an image showing the difference between a Fourier phase of a ground truth of an object captured without distortion and a Fourier phase of 50p, and 52 is an image showing a Fourier amplitude of 50p.

Referring to the right side, 50a is a reconstructed image in which an object is reconstructed from the original images and may correspond to Iₚₒₛₜ(\vec{r}) described above. 53 is an image showing the difference between a Fourier phase of a ground truth of an object captured without distortion and a Fourier phase of 50a, indicating that φ(\vec{k}) described above is the same as the ground truth. 54 is an image showing a Fourier amplitude of 50a and may correspond to

$$\vert {\tilde{I}}_{avg} ( \vec{k} ) \vert = \sqrt{\frac{1}{N} \sum {\vert {\tilde{I}}_{n} ( \vec{k} ) \vert}^{2}}$$

described above.

A reconstructed image represented as 50a may be acquired by multiplying the Fourier phase represented as the image of 51 of each of the n original images and the Fourier amplitude value represented as the image of 52 and performing an inverse Fourier transform thereon. The Fourier phase and Fourier amplitude of the reconstructed image 50a may be extracted as represented in 53 and 54. That is, when an operation according to operations S200 to S400 or operations S200 to S500 described above is performed using the Fourier phase 51 and the Fourier amplitude 52 of each of the n original images (for convenience of description, only the difference between the Fourier phase of one original image and the Fourier phase of the ground truth and those Fourier amplitudes are shown in 51 and 52), the Fourier phase 53 and the Fourier amplitude 54 of the reconstructed image may be acquired, and the final reconstructed image 50a may be acquired by multiplying the values expressed by 53 and 54 and performing Fourier transform operation thereon.

Finally comparing 50p and 50a, it may be learned that the object included in the reconstructed image 50a is much more clearly shown.

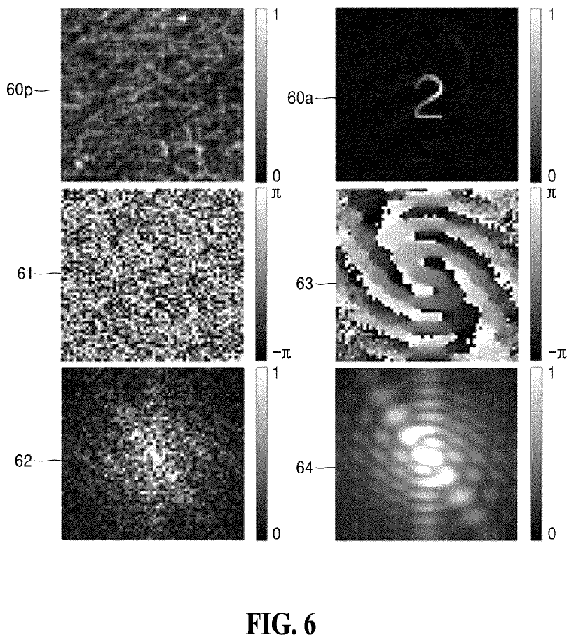

FIG. 6 is a mimetic diagram for describing an image reconstruction method using example images according to another embodiment of the present disclosure. Left images 60p, 61, and 62 of FIG. 6 are images acquired in a distorted state before reconstruction, and right images 60a, 63, and 64 are images acquired in a reconstructed state.

In the embodiment of FIG. 6, the original images are distorted much more than those in FIG. 5 described above, and the degree of distortion is much more serious when referring to an original image 609 and a reconstructed image 60a. Except that the degree of distortion is serious, the description as provided with reference to FIG. 5 applies hereto, and thus, the difference will be mainly described hereinafter.

Referring to the left side first, 60p is one of the plurality of original images including a distorted region and may correspond to Iₙ(\vec{r}) described above or ΣI_{n,corr}(\vec{r}) that is an image shift-corrected therefrom. 61 is an image showing the Fourier phase of 60p, and 62 is an image showing the Fourier amplitude of 60p.

Referring to the right side, 60a is a reconstructed image in which an object is reconstructed from the original images and may correspond to Iₚₒₛₜ(\vec{r}) described above. 63 is an image showing the Fourier phase of 60a and may correspond to φ(\vec{k}) described above, and 64 is an image showing the Fourier amplitude of 60a and may correspond to

$$\vert {\tilde{I}}_{avg} ( \vec{k} ) \vert = \sqrt{\frac{1}{N} \sum {\vert {\tilde{I}}_{n} ( \vec{k} ) \vert}^{2}}$$

described above.

Finally comparing 60p and 60a, it may be learned that the text of “2”, which is an object to be reconstructed from the seriously distorted original image 60p, is reconstructed clearly in the reconstructed image 60a.

When distorted seriously, the original image 60p may include much more distortion information of the object. Thus, the original image 60p shown in FIG. 6 may be provided as a single image, and instead, the single original image 60p may be divided into a plurality of (e.g., n) sub-regions, and a plurality of sub-images respectively corresponding to the sub-regions may be acquired. At this time, adjacent sub-regions may include an overlapping portion. The number of divided sub-regions may be, for example, hundreds or thousands, but is not limited thereto. At this time, 61 and 62 shown in FIG. 6 may correspond to the Fourier phase and Fourier amplitude of each of the sub-images.

Similar to FIG. 5, when an operation according to operations S200 to S400 or operations S200 to S500 described above is performed using the Fourier phase 61 and the Fourier amplitude 62 of each of the n sub-images, the Fourier phase 63 and the Fourier amplitude 64 of the reconstructed image may be acquired, and the final reconstructed image 60a may be acquired by multiplying the values expressed by 63 and 64 and performing Fourier transform operation thereon.

One or more of the above embodiments of the present disclosure may be embodied in the form of a computer program that can be executed by a computer through various elements. The computer program may be recorded on a non-transitory computer-readable recording medium. At this time, the medium may store computer-executable programs. Examples of the medium include magnetic media (e.g., hard disks, floppy disks, and magnetic tapes), optical media (e.g., CD-ROMs and DVDs), magneto-optical media (e.g., floptical disks), and those configured to store program commands (e.g., ROMs, RAMs, and flash memories), etc.

Meanwhile, the computer programs may be specially designed and configured or well known to one of ordinary skill in the computer software field. Examples of the computer programs include machine code produced by a compiler and high-level code executable by a computer using an interpreter.

In addition, although preferred embodiments of the present disclosure were illustrated and described above, the present disclosure is not limited to the specific embodiments and may be modified in various ways by one of ordinary skill in the art to which the present disclosure pertains without departing from the scope of the present disclosure described in claims, and the modified implementations should not be construed independently from the technical ideal or perspective of the present disclosure.

Therefore, the spirit of the present disclosure should not be limited to the embodiments described above, but the claims and their equivalents or the entire scope of equivalent changes therefrom are fall within the scope of the spirit of the present disclosure.

1. A method of reconstructing an object from distorted images, the method comprising:
acquiring a plurality of original images comprising a distorted region;
extracting the Fourier phase with respect to the original images;
extracting the Fourier amplitude with respect to the original images; and
acquiring a reconstructed image in which the distorted region has been reconstructed by performing an inverse Fourier transform on a value obtained by multiplying the Fourier phase and the Fourier amplitude,
wherein the extracting of the Fourier phase and the extracting of the Fourier amplitude are performed independently of each other.

2. The method of claim 1, wherein the extracting of the Fourier phase comprises:
acquiring an aligned image set by aligning the plurality of original images using shift correction;
acquiring an average image of the aligned image set; and
extracting the Fourier phase from the average image.

3. The method of claim 1, wherein the extracting of the Fourier phase comprises:
selecting a reference image that is a reference for shift correction from among the plurality of original images;
performing shift correction with respect to the plurality of original images comprising the reference image based on the reference image using a cross-correlation operation that calculates a correlation with the reference image;
acquiring a summed image by summing the shift-corrected images; and
calculating a Fourier phase of the summed image.

4. The method of claim 1, wherein the plurality of original images are acquired as a plurality of images from different timepoints.

5. The method of claim 1, wherein the plurality of original images are acquired by dividing a single original image acquired as a single image from one timepoint into a plurality of sub-images satisfying an isoplanatic condition.

6. The method of claim 1, further comprising:
after the acquiring of the reconstructed image,
determining whether an iteration count reaches a preset maximum iteration count,
wherein when the iteration count does not reach the preset maximum iteration count yet in the determining,
the method determines a reconstructed image acquired most recently to be a reference image for a next cycle, and acquires a subsequent reconstructed image by extracting the Fourier phase and the Fourier amplitude with respect to the same plurality of original images.

7. The method of claim 1, wherein in the acquiring of the original images,
the original images are acquired by being captured by a spatial sensor device comprising at least one of a camera, an ultrasonic sensor, a radio antenna, or an X-ray detector.

8. An apparatus for reconstructing an object from a distorted image, the apparatus comprising:
a processor,
wherein the processor is configured to:
acquire a plurality of original images comprising a distorted region,
extract a Fourier phase with respect to the original images,
extract a Fourier amplitude with respect to the original images, and
acquire a reconstructed image in which the distorted region has been reconstructed by performing an inverse Fourier transform on a value obtained by multiplying the Fourier phase and the Fourier amplitude,
wherein the extracting of the Fourier phase and the extracting of the Fourier amplitude are performed independently of each other.
